(19) United States
(12) Patent Application Publication
(10) Pub. No.: US 2009/0216755 A1
(43) Pub. Date: Aug. 27, 2009

(54) Indexing Method For Multimedia Feature Vectors Using Locality Sensitive Hashing

(76) Inventor: Einav Itamar, Ramat-Gan (IL)

Correspondence Address: The Law Office of Michael E. Kondoudis, PC, 888 16th Street, N.W., Suite 800, Washington, DC, 20006, US

(21) Appl. No.: 12/388,795

(22) Filed: Feb. 19, 2009

Related U.S. Application Data
(60) Provisional application No. 61/064,187, filed on Feb. 21, 2008.

(51) Int. Cl. G06F 17/30; G06F 7/10

(52) U.S. Cl. 707/5; 707/102; 707/E17.017; 707/E17.009

(57) ABSTRACT

A computer implemented method for indexing multimedia vectors and for searching and retrieving a query vector using a locality sensitive hashing. Indexing is performed by calculating hash codes from the multimedia vectors using several hash functions. Each hash code is a different subset of the entries in the hash vector. The method utilizes the structure of the hash vector space in order to define the hash codes in a way that improves the retrieval efficiency. Retrieval is performed by applying the hash functions to a query vector and measuring the distances between the query vector and multimedia vectors with hash codes identical to the hash codes of the query vector.

### CROSS REFERENCE

This application claims priority from U.S. provisional patent application No. 61/064,187 filed on Feb. 21, 2008, the content of which is incorporated herein by reference in its entirety.

### TECHNICAL FIELD

The present invention generally relates to the field of search methods, and more particularly to an indexing method using hash functions

### BACKGROUND OF THE RELATED ART

Searching large databases of multimedia objects is becoming an ever more common task. Usually, multimedia objects are represented mathematically by high order multidimensional vectors. Searching a query object in a database involves calculating the distances between the query objects and all objects in the database using a distance function. In large databases of multimedia objects this task becomes extremely complicated.

U.S. Pat. No. 5,893,095, which is incorporated herein by reference in its entirety, discloses a similarity engine for content-based retrieval of images, a technique which explicitly manages image assets by directly representing their visual attributes. U.S. Pat. No. 6,084,595, which is incorporated herein by reference in its entirety, discloses an indexing method for image search engine wherein all images within a distance threshold will be identified by the query. U.S. Pat. No. 6,418,430, which is incorporated herein by reference in its entirety, discloses a system for efficient content-based retrieval of images using a visual image index with multi-level filtering.

### BRIEF SUMMARY

Embodiments of the present invention provide a computer implemented method for indexing a plurality of multimedia vectors. The computer implemented method comprises calculating at least one hash vector from the multimedia vectors using a plurality of hash vector functions and calculating a plurality of hash codes from each hash vector using a hash code function.

In embodiments, according to an aspect of the present invention, the computer implemented method further comprises retrieving a query vector. Retrieving comprises calculating a query hash vector from the query vector using the hash vector functions, calculating a plurality of query hash codes from the query hash vector with the hash code function, finding close multimedia vectors by comparing hash codes and query hash codes using a comparison function, and calculating distances between the query vector and the close multimedia vectors using a distance function. Finally multimedia vectors with distances below a threshold are retrieved.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIGS. 1A, 1B and 1C are block diagrams illustrating a computer implemented method for searching a query vector among multimedia vectors according to some embodiments of the invention;

FIG. 2 is an illustration of the transformations of the multimedia vectors and a query vector, as realized in a computer usable program code tangibly embodied on a computer usable medium as part of a computer program product according to some embodiments of the invention; and

FIG. 3 is a block diagram illustrating a data processing system for searching a query vector among a plurality of multimedia vectors, according to some embodiments of the invention.

The drawings together with the following detailed description make apparent to those skilled in the art how the invention may be embodied in practice.

### DETAILED DESCRIPTION

The present invention discloses a computer implemented method for indexing a plurality of multimedia vectors and for searching and retrieving a query vector using a locality sensitive hashing. The computer implemented method applies hash functions to form hash vectors from the multimedia vectors and then chooses several hash codes from each hash vector, such that the hash codes are from subspaces of the hash vector space. Each hash code is a different subset of the entries in the hash vector. The method utilizes the structure of the hash vector space in order to define the hash codes in a way that improves the retrieval efficiency.

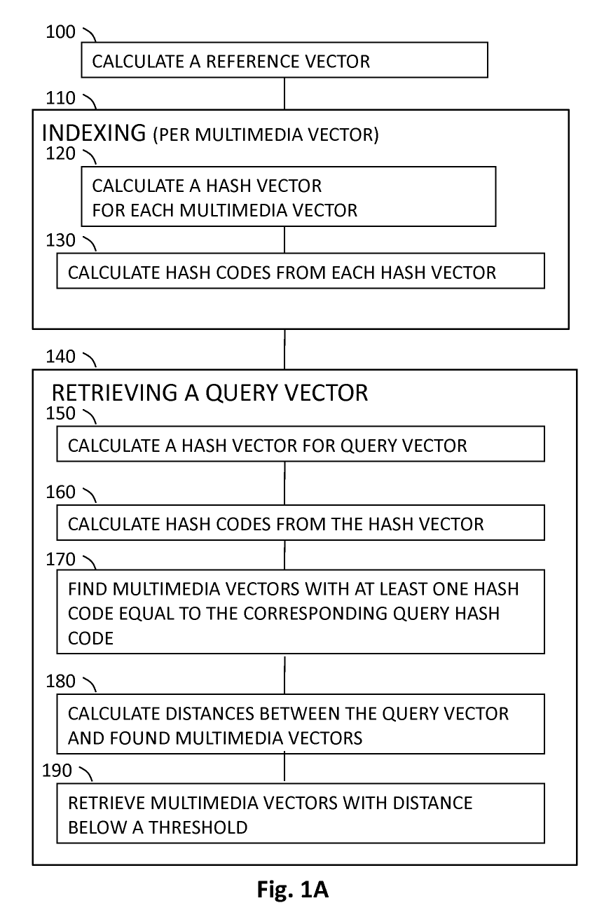

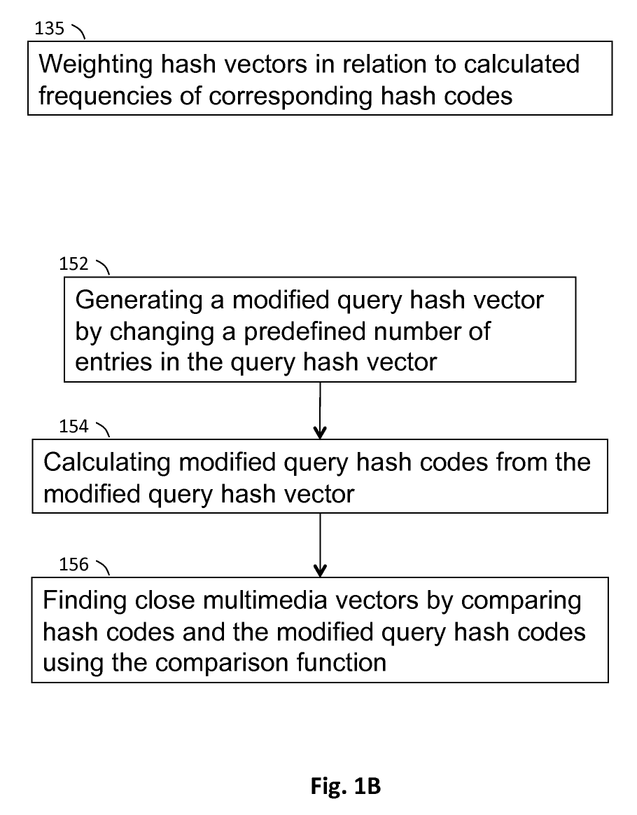

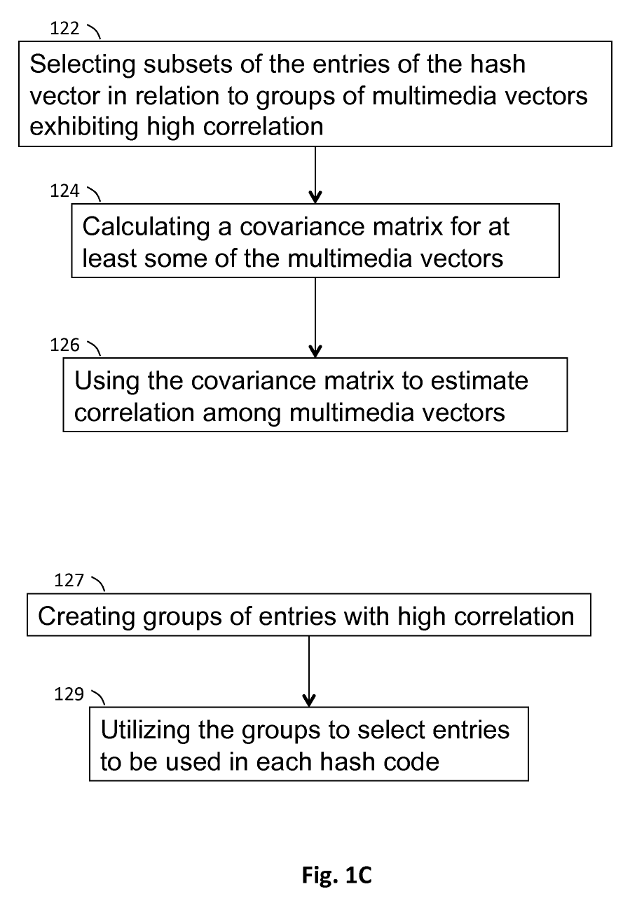

FIGS. 1A, 1B and 1C are block diagrams illustrating a computer implemented method for searching a query vector 260 among multimedia vectors 200 according to some embodiments of the invention. In a non-limiting example, the computer implemented method comprises calculating a reference vector 220 from multimedia vectors 200 (step 100) using a reference producing function 210, indexing multimedia vectors 200 (step 120) and retrieving query vector 260 (step 140). Indexing multimedia vectors 200 (step 120) comprises calculating hash vectors 240 from multimedia vectors 200 and reference vector 220 (step 120) using a hash vector function 230, and calculating hash codes 250 from hash vectors 240 (step 130) using a hash code function 245. Retrieving query vector 260 (step 140) comprises calculating a hash vector 240A from query vector 260 and reference vector 220 (step 150) with hash vector function 230, calculating query hash codes from hash vector 240 (step 160), finding close multimedia vectors 200A by comparing hash codes 250 to query hash codes 250A (step 170) using a comparison function 235, calculating distances between query vector 260 and close multimedia vectors 200A (step 180) using a distance function 270, and retrieving multimedia vectors with distances below a threshold (step 190).

According to some embodiments of the invention, the computer implemented method does not include calculating reference vector 220 from multimedia vectors 200 (step 100) using a reference producing function 210. Instead, hash functions are used to directly calculate hash vector 240 from multimedia vectors 200.

According to some embodiments of the invention, reference producing function 210 calculates reference vector 220 such that reference vector 220 splits a space comprising multimedia vectors 200 substantially in a uniform manner thus increasing the efficiency of the method. For example, reference vector 220 may be calculated as an average over a subset of multimedia vectors 200.

According to some embodiments of the invention, the computer implemented method for indexing multimedia vectors 200 (step 120) comprises: calculating hash vectors 240 from multimedia vectors 200 using a plurality of hash functions, and generating hash codes 250 from each hash vector 240 by taking a subset of the entries of hash vector 240 into each hash code 250. In such a way, each hash code 250 is over a different subspace of the space consisting hash vectors 240. This method of indexing results in a locality sensitive hashing.

According to some embodiments of the invention, finding close multimedia vectors (step 170) may comprise weighting hash vectors 240 in relation to calculated frequencies of corresponding hash codes 250 (step 135). For example, hash vectors 240 that relate to common hash codes 250 may be given a low score. Hash vectors 240 that relate to very frequent hash codes 250 may be eliminated.

According to some embodiments of the invention, finding close multimedia vectors (step 170) may comprise generating a modified query hash vector 240A by changing a predefined number of entries in query hash vector 240A (step 152); calculating modified query hash codes from the modified query hash vector (step 154); and finding close multimedia vectors 200 by comparing hash codes 250 and the modified query hash codes using comparison function 235 (step 156). As query vector 260 and a close multimedia vector 200 may have different hash codes 250A, 250, when some of the entries in corresponding query vectors 240A, 240 are close to the corresponding entries on reference vector 220, the method may comprise making small changes to query vector 260 and re-calculating query hash codes 250A.

According to some embodiments of the invention, subsets of the entries of hash vector 240 may be selected in relation to groups of multimedia vectors 200 exhibiting high correlation (step 122). Correlation may be calculated by calculating a covariance matrix for at least some of multimedia vectors 200 (step 124) and using the covariance matrix to estimate correlation among multimedia vectors 200 (step 126).

According to some embodiments of the invention, the computer implemented method may further comprise creating groups of entries with high correlation (step 127) and utilizing the groups to select entries to be used in each hash code 250 (step 129).

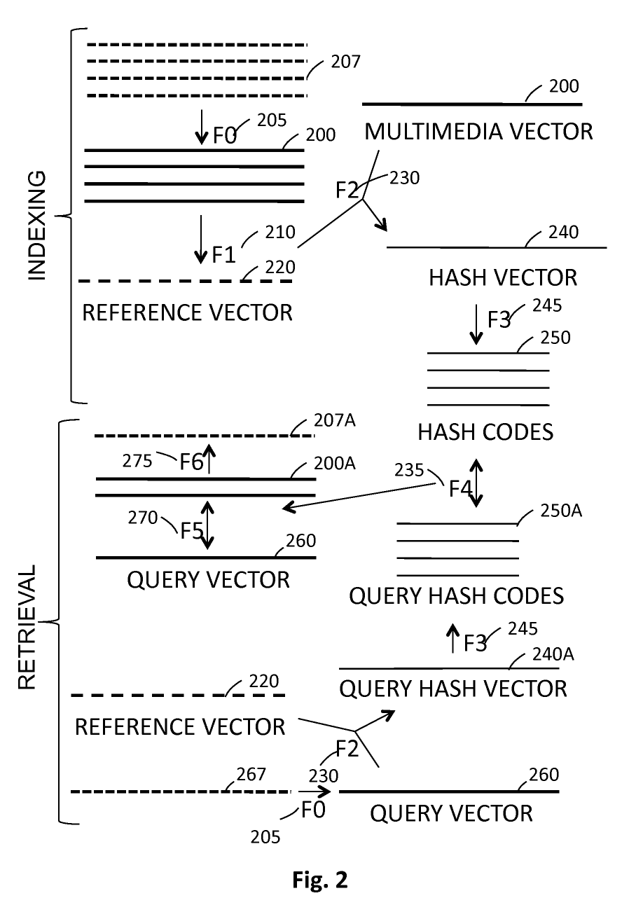

FIG. 2 is an illustration of the transformations of multimedia vectors 200 and query vector 260, as realized in a computer usable program code tangibly embodied on a computer usable medium as part of a computer program product according to some embodiments of the invention. A preparatory step is to convert multimedia objects 207 into multimedia vectors 200 using a description function 205. The indexing commences with calculating reference vector 220 from multimedia vectors 200 with reference producing function 210. Then, hash vectors 240 are calculated from multimedia vectors 200 and reference vector 220 with hash vector function 230. Finally, hash codes 250 are calculated from hash vectors 240 with hash code function 245. According to some embodiments of the invention, the hash codes are indexed together with multimedia vectors and a multimedia object indicator to the corresponding multimedia object.

Retrieval of query vector 260 begins with a preparatory step of calculating query vector 260 from query object 267 using description function 205. This step is followed by calculating query hash vectors 240A from query vector 260 and reference vector 220 using hash vector function 230, and calculating query hash codes 250A from hash vectors 240A with hash code function 245. Then, query hash codes 250A are compared with hash codes 250 of multimedia vectors 200. Close multimedia vectors 200A are found comparing hash codes 250 with query hash code 250A using a comparison function 235. As a last step, distances between query vector 260 and close multimedia vectors 200A are calculated with distance function 270, and multimedia vectors with distances below a threshold are retrieved. According to some embodiments of the invention, the retrieval goes on and utilizes the multimedia object indicator for accessing the corresponding multimedia object.

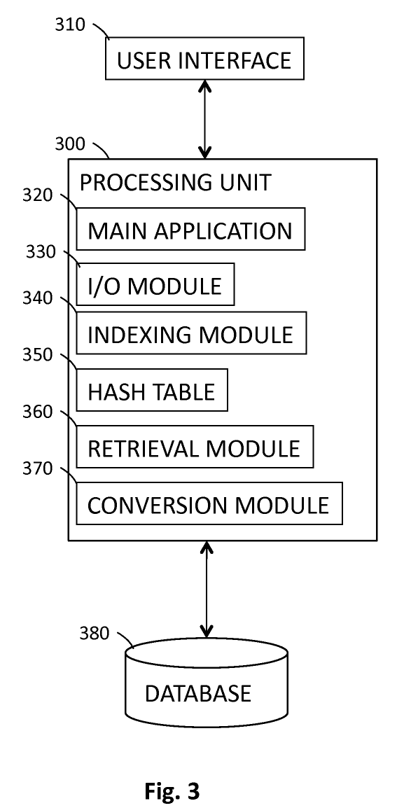

FIG. 3 is a block diagram illustrating a data processing system for searching a query vector 260 among a plurality of multimedia vectors 200, according to some embodiments of the invention. The data processing system comprises a database 380 with multimedia vectors 200, a user interface 310 configured to input query vector 260 and output multimedia vectors 200 and a processing unit 300. Processing unit 300 comprises a main application 320 for calculating at least one reference vector 220 from multimedia vectors 200 using a reference producing function 210, and configured to control the working of processing unit 300. Processing unit 300 further comprises an indexing module 340 for calculating hash vectors and hash codes from multimedia vectors 200 and the reference vector. Processing unit 300 further comprises a hash table 350 for storing hash codes 250 of multimedia vectors 200 calculated by indexing module 340. Processing unit 300 further comprises a retrieval module 360 for calculating hash vectors 240A and query hash codes 250A from query vector 260, for finding close multimedia vectors 200A close to query vector 260 by comparing hash codes 250 stored in hash table 350 and query hash codes 250, and calculating distances between query vector 260 and close multimedia vectors 200A, and retrieve found multimedia vectors. Processing unit 300 further comprises an I/O module 330 configured to receive query vector 260 from user interface 310 and send found multimedia vectors to user interface 310. Processing unit 300 further comprises a description module 370 for converting multimedia objects 207 into multimedia vectors 200.

According to some embodiments of the invention, the hash function is formed by the composition of hash vector function 230 and hash code function 245.

According to some embodiments of the invention, reference producing function 210 calculates reference vector 220 using a subset of dimensions from multimedia vector 200. For example reference producing function 210 may give reference vector 220 at each dimension a value equal to the median of the values of multimedia vectors 200 of the subset.

According to some embodiments of the invention, hash vectors 240 are vectors over the binary field.

According to some embodiments of the invention, reference producing function 210 calculates several reference vectors 220 from multimedia vectors 200.

According to some embodiments of the invention, hash vector function 230 determines the value of hash vector 240 in each dimension by comparing the value of multimedia vector 200 in the same dimension with the value of reference vector 220 in the same dimension.

According to some embodiments of the invention, hash code function 245 calculates hash codes 250 from hash vector 240 by mapping hash vector space on a space of a smaller dimension.

According to some embodiments of the invention, comparison function 235 declares multimedia vector 200 close to query vector 260 if at least one hash code 250 is equal to at least one query hash code 250A.

According to some embodiments of the invention, distance function 270 is the Euclidian distance.

According to some embodiments of the invention, multimedia vector 200 is over the field of real numbers. Conversion of multimedia objects 207 to multimedia vectors 200, conversion of the query object 267 to query vector 260, and conversion of found multimedia vectors 200A to found multimedia object 207A takes place using standard procedures.

According to some embodiments of the invention, each hash code 250 is calculated from multimedia vector 200 directly, using a single hash function. Several different hash functions are used to produce hash codes 250 from multimedia vector 200 and to produce query hash codes 250A from query vector 260.

According to some embodiments of the invention, locality is reached by using hash codes 250 that are subsets of the entries of hash vector 240. The number of hash codes 250 and the size of the subsets they represent are chosen in a way that balances the sensitivity to local changes with a certain amount of overlap among hash codes 250.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A computer implemented method of indexing a plurality of multimedia vectors, the computer implemented method comprising:
calculating at least one hash vector from the plurality of multimedia vectors using a plurality of hash functions, wherein the at least one hash vector comprises a plurality of entries; and
generating a plurality of hash codes from the at least one of hash vector,
wherein each of the plurality of hash codes comprises a different subset of the entries of the corresponding hash vector.

2. The computer implemented method of claim 1, wherein each hash function is formed by a composition of a hash vector function and a hash code function, wherein the hash vector function is used to calculate at least one hash vector from the plurality of multimedia vectors and at least one reference vector and wherein the hash code function is used to calculate the plurality of hash codes from the plurality of hash vectors.

3. The computer implemented method of claim 1, wherein each hash code is calculated from a multimedia vector directly, using a single hash function.

4. The computer implemented method of claim 1, wherein the plurality of hash vectors comprises vectors over at least one of: the binary field, the field of real numbers.

5. The computer implemented method of claim 1, wherein at least one hash function determines the value of each hash vector in each dimension by comparing a value of a multimedia vector in the same dimension with a value of the reference vector in the same dimension.

6. The computer implemented method of claim 1, further comprising selecting the subsets of the entries of the corresponding hash vector in relation to groups of the plurality of multimedia vectors exhibiting high correlation.

7. A computer implemented method of indexing a plurality of multimedia vectors, the computer implemented method comprising:
calculating at least one reference vector from the plurality of multimedia vectors using a reference producing function; and
indexing the plurality of multimedia vectors comprising:
calculating at least one hash vector from the plurality of multimedia vectors and the at least one reference vector using a hash vector function; and
calculating a plurality of hash codes from the plurality of hash vectors using a hash code function.

8. The computer implemented method of claim 7, wherein the reference producing function calculates the at least one reference vector using a subset of dimensions from the plurality of multimedia vector.

9. The computer implemented method of claim 7, wherein the reference producing function calculates the at least one reference vector such that the at least one reference vector splits a space comprising the plurality of multimedia vectors substantially in a uniform manner.

10. The computer implemented method of claim 7, wherein the plurality of hash vectors comprise vectors over at least one of: the binary field, the field of real numbers.

11. The computer implemented method of claim 7, wherein the hash vector function determines the value of each hash vector in each dimension by comparing a value of a multimedia vector in the same dimension with a value of the reference vector in the same dimension.

12. The computer implemented method of claim 7, wherein the hash code function calculates the hash codes from each hash vector by mapping the hash vector space on a space of a smaller dimension.

13. The computer implemented method of claim 7, further comprising searching and retrieving a query vector comprising:
calculating a query hash vector from the query vector and the at least one reference vector with the hash vector function;
calculating a plurality of query hash codes from the query hash vector with the hash code function; and
finding close multimedia vectors by comparing hash codes and query hash codes using a comparison function.

14. The computer implemented method of claim 13, wherein said finding close multimedia vectors comprises weighting hash vectors in relation to calculated frequencies of corresponding hash codes.

15. The computer implemented method of claim 13, wherein said finding close multimedia vectors comprises:
generating a modified query hash vector by changing a predefined number of entries in the query hash vector;
calculating a plurality of modified query hash codes from the modified query hash vector; and
finding close multimedia vectors by comparing hash codes and modified query hash codes using the comparison function.

16. The computer implemented method of claim 13, further comprising:
calculating distances between the query vector and the close multimedia vectors using a distance function; and
retrieving multimedia vectors with the distances below a threshold.

17. The computer implemented method of claim 13, wherein the comparison function declares a multimedia vector close to a query vector if at least one hash code is equal to at least one query hash code.

18. The computer implemented method of claim 13, wherein the distance function is the Euclidian distance.

19. The computer implemented method of claim 13, wherein the hash code function calculates the hash codes from each hash vector by mapping the hash vector space on a space of a smaller dimension.

20. The computer implemented method of claim 13, wherein each hash code is a subset of the entries of one of the plurality of hash vectors, such that the computer implemented method exhibits locality.

21. The computer implemented method of claim 20, further comprising selecting the subset of the entries in relation to groups of multimedia vectors with high correlation.

22. The computer implemented method of claim 21, further comprising calculating a covariance matrix for at least some of the plurality of multimedia vectors and using the covariance matrix to estimate correlation among multimedia vectors.

23. The computer implemented method of claim 20, wherein the subset is chosen such as to balance between sensitivity to local changes and an amount of overlap among the plurality of hash codes.

24. A data processing system for searching a query vector among a plurality of multimedia vectors, the data processing system comprising:
a database with the multimedia vectors;
a user interface configured to input the query vector and output the multimedia vectors; and
a processing unit comprising:
a main application for calculating at least one reference vector from the plurality of multimedia vectors using a reference producing function, and configured to control the working of the processing unit;
an indexing module for calculating at least one hash vector and hash codes from the plurality of multimedia vectors and the reference vector;
a hash table for storing the hash codes of the multimedia vectors calculated by the indexing module;
a retrieval module for calculating at least one hash vector and hash codes from the query vector, for finding close multimedia vectors close to the query vector by comparing hash codes stored in the hash table and query hash codes and calculating distances between the query vector and the close multimedia vectors, and retrieve found multimedia vectors;
an I/O module configured to receive the query vector from the user interface and send the found multimedia vectors to the user interface; and
a description module for converting multimedia objects into multimedia vectors.

25. The data processing system of claim 24, wherein the plurality of hash vectors comprise vectors over at least one of: the binary field, the field of real numbers.

26. The data processing system of claim 24, wherein the distance function is the Euclidian distance.

27. A computer program product for searching a query vector among a plurality of multimedia vectors, the computer program product comprising a computer usable medium having computer usable program code tangibly embodied thereon, the computer usable program code comprising:
computer usable program code for converting multimedia objects into multimedia vectors;
computer usable program code for calculating at least one reference vector from the plurality of multimedia vectors using a reference producing function;
computer usable program code for indexing the plurality of multimedia vectors comprising:
computer usable program code for computer usable program code for calculating at least one hash vector from the plurality of multimedia vectors and the at least one reference vector using a hash vector function; and
computer usable program code for calculating a plurality of hash codes from the plurality of hash vectors using a hash code function, and
computer usable program code for retrieving a query vector comprising:
computer usable program code for calculating a query hash vector from the query vector and the at least one reference vector with the hash vector function;
computer usable program code for calculating a plurality of query hash codes from the query hash vector with the hash code function;
computer usable program code for finding close multimedia vectors by comparing hash codes and query hash codes using a comparison function;
computer usable program code for calculating distances between the query vector and the close multimedia vectors using a distance function; and
computer usable program code for retrieving multimedia vectors with the distances below a threshold.

28. The computer implemented method of claim 27, wherein the hash vector function determines the value of each hash vector in each dimension by comparing a value of a multimedia vector in the same dimension with a value of the reference vector in the same dimension.

29. The computer implemented method of claim 27, wherein the hash code function calculates the hash codes from each hash vector by mapping the hash vector space on a space of a smaller dimension.

30. The computer program product of claim 27, wherein the comparison function declares a multimedia vector close to a query vector if at least one hash code is equal to at least one query hash code.
